(19) United States
(12) Patent Application Publication
(10) Pub. No.: US 2003/0154244 A1
(43) Pub. Date: Aug. 14, 2003

(54) Method and system to provide flexible HTTP tunnelling

(76) Inventors: Mark H. Zellers, Mountain View, CA (US); Jon S. McCarty, San Jose, CA (US)

Correspondence Address: Sawyer Law Group LLP, P. O. Box 51418, Palo Alto, CA, 94303, US

(21) Appl. No.: 10/077,695

(22) Filed: Feb. 13, 2002

(51) Int. Cl. G06F 15/16

(52) U.S. Cl. 709/203; 709/228; 709/230

(57) ABSTRACT

Systems and methods to, for example, allow a series of HTTP request/response transactions to be used to emulate a more fully bi-directional communications channel between a client and a server in a communications network are presented. The client and the server create software objects that can represent both direct connections or connections via intermediary servers such as proxy servers or relay servers, hide the underlying limitations of the transport from the application using it, and in so doing, simplify the programming interface for an application programmer.

### TECHNICAL FIELD

The present invention relates to computing networks and communications, and, more particularly, to emulating bi-directional communication between a client and a server in the presence or absence of a proxy server.

### BACKGROUND

As is well known, in a client/server relationship, a client makes requests of a server and the server in turn services those requests, returning responses to the client. Clients and servers typically exchange information by use of sockets which allow for bi-directional communication, where either side is free to send or receive data at will. If one side in a server-client pair attempts to receive data before the other side has written to the socket, the attempt to receive data will be blocked, pending the other side writing the data to the other side of the socket.

Although in the simplest case, systems such as clients and servers can communicate directly, in most practical cases over an untrusted, outside network such as the Internet, it is very common for systems that may need to communicate with each other to be separated by a firewall, a proxy server, or some combination thereof. A firewall prevents the establishment of, for example, Transmission Control Protocol (TCP) connections from inside of the protected network to the outside network. Proxy servers are used to enable certain communications from behind or inside the firewall to outside, without allowing untrusted machines outside the protected network to connect directly to trusted machines on the inside.

It is very common for proxy servers to support the HTTP protocol and it is also very common for a proxy server to be part of a firewall installation. It is often easier to use the HTTP protocol to connect from the outside of the firewall to a server inside the firewall than it is to arrange to have the firewall allow communication between the client and the server, that is, to allow communication between machines on the trusted and untrusted sides of the firewall. If an arbitrary, non-standard protocol other than HTTP is used then it may be difficult or impossible to deploy a given system if an administrator of the firewall is unwilling or unable to allow the protocol to flow through the firewall. Such an implementation may involve going to the firewall vendor and requesting special code in the firewall to handle the desired, non-standard protocol. By encapsulating an arbitrary message in HTTP, it is possible to arrange for the proxy server to relay such a message from an originating machine behind the firewall to a machine outside of the trusted network.

Some operations can be handled with just a simple request and reply. Such interactions can be mapped very easily onto HTTP, simply by prepending the appropriate headers to the messages.

Some interactions between the client and the server are more complex. Some requests from the client often require multiple response messages from the server for a single request or need multiple requests to elicit one or more responses from the server. Since HTTP transactions are limited to a single request/response pair, it is difficult to emulate more elaborate protocols, where, for example, one side in the server/client pair may wish to send or receive multiple messages. For example, if the multiple requests (responses) from one operation were condensed into a single request (response) to fit the HTTP single request, single response paradigm, the single request (response) in many cases could involve sending potentially large amounts of information that might exceed optimally available buffer sizes or might be expensive to design for. For these reasons, such complex interactions do not map well onto the HTTP protocol.

It is possible to use two completely distinct methods of communication between the client and server at the application level, one method that handles a direct connection without a proxy and one method that handles an indirect connection via a proxy server. Although such an implementation would be efficient and specialized, the implementation would be not be simple to maintain and would present design challenges for the application programmer.

It is also possible to treat all types of connections in the same manner, so that the same pattern of requests and responses are used, regardless of whether the server and the client are directly connected via, for example, TCP or whether the client communicates with the server via an HTTP proxy server, for example. Such a workaround would effectively degenerate the case in the direct connection, as unnecessary requests and responses would be forwarded between the client and server in order to maintain consistency between the two connections. This is therefore a strategy that creates an inefficient and unwieldy implementation that has high overhead costs.

Accordingly, it would be desirable to provide an efficient, readable, reliable, and maintainable alternative communication scheme that does not suffer from the above-described drawbacks and weaknesses.

### SUMMARY

The presently preferred embodiments described herein include systems and methods for emulating a bi-directional communications connection between a server and a client and for automatically adapting to the presence or absence of an intermediary server between the server and the client. The methods and systems described herein according to aspects of the present invention allow a series of HTTP request/response transactions to be used to emulate a more fully bi-directional communications channel between a client and a server in a communications network. The client and the server create software objects, or circuit objects, that can represent both direct connections or connections via intermediary servers such as proxy servers or relay servers, hide the underlying limitations of the transport from the application using it, and in so doing, simplify the programming interface for an application programmer.

According to aspects of the present invention, software objects in the client and the server exchange messages using an available communication protocol. The communication protocol that is used is selected according to the presence or absence of intermediary servers between the server and the client that may not support all of the available communication protocols. The selected communication protocol is supported by the client, the server, and all intermediaries. When the protocol selected is not a bi-directional protocol, the software objects insert and consume additional messages to maintain the conversation between the server and the client. The inserted messages are invisible to the application programs using these software objects.

A method of maintaining a conversation between a server and a client using either a bi-directional or a non-bi-directional communication protocol is presented according to one aspect of the invention. According to the method, a client software object is created at the client to initiate a connection with the server and to manage a conversation between the server and the client from the perspective of the client. A selected communication protocol is selected from a set of available communication protocols that are supported by the client, the server, and any intermediary servers between the client and the server. If the selected communication protocol is a bi-directional communication protocol, then bi-directional communication protocol messages are exchanged between the server and the client, and control over the conversation is transferred to the bi-directional communication protocol. If the selected communication protocol is a non-bi-directional communication protocol, then regular non-bi-directional communication protocol messages are exchanged between the server and the client, additional non-bi-directional communication protocol messages are inserted as needed to maintain the conversation, and several of the regular and additional non-bi directional communication protocol messages are connected as the conversation to emulate bi-directional communication between the client and the server. Client application programming is layered over the client software object and the conversation so that the conversation appears fully bi-directional to the client application programming.

A method of maintaining a conversation between a server and a client using a communication protocol is presented according to a further aspect of the invention. Either one supported protocol of several bi-directional communication protocols or one available protocol of several non bi-directional communication protocols is used as the communication protocol, depending on whether a need exists to communicate via at least one intermediary server that does not support any of the several bi-directional communication protocols. According to the method, a server software object is created at the server to process protocol messages and to manage a conversation between the server and the client from the perspective of the server. If there is no intermediary server present between the server and the client that does not support any of the several bi-directional communication protocols, then supported bi-directional communication protocol messages are exchanged between the server and the client, and control over the conversation is transferred to the supported bi-directional communication protocol. If at least one intermediary server is present between the server and the client that does not support any of the several bi-directional communication protocols, then messages of a first type according to the available non-bi-directional communication protocol are exchanged between the server and the client, messages of a second type, for example, dummy messages, according to the available non-bi-directional communication protocol are inserted as needed to maintain the conversation, and several messages of the first and second types are connected as the conversation to emulate bi-directional communication between the client and the server. Application programming is layered over the server software object and the conversation so that the conversation appears fully bi-directional to the application programming and so that the messages of the second type are concealed from the application programming.

A method of maintaining a conversation between a server and a client using a communication protocol is presented according to another aspect of the invention. Either a bi-directional communication protocol or a non bi-directional communication protocol is used as the communication protocol, depending on whether a need exists to communicate via at least one intermediary server that does not support the bi-directional communication protocol. According to the method, a server software object is created at the server to process protocol messages and to manage a conversation between the server and the client from the perspective of the server. If there is no intermediary server present between the server and the client that does not support the bi-directional communication protocol, then bi-directional communication protocol messages are exchanged between the server and the client, and control over the conversation is transferred to the bi-directional communication protocol. If at least one intermediary server is present between the server and the client that does not support the bi-directional communication protocol, then regular non-bi-directional communication protocol messages are exchanged between the server and the client, additional non-bi-directional communication protocol messages are inserted as needed to maintain the conversation, and several of the regular and additional non-bi directional communication protocol messages are connected as the conversation to emulate bi-directional communication between the client and the server. Application programming is layered over the server software object and the conversation so that the conversation appears fully bi-directional to the application programming.

A method of maintaining a conversation between a server and a client using a communication protocol is presented according to a further aspect of the invention. Either a bi-directional communication protocol or a non bi-directional communication protocol is used as the communication protocol, depending on whether a need exists to communicate via at least one intermediary server that does not support the bi-directional communication protocol. According to the method, a server software object is created at the server to process protocol messages and to manage a conversation between the server and the client from the perspective of the server. Whether or not there is at least one intermediary server present between the server and the client is determined. If there is no intermediary server present, then bi-directional communication protocol messages are exchanged between the server and the client, and control over the conversation is transferred to the bi-directional communication protocol. If at least one intermediary server that is compatible with the non-bi-directional communication protocol is present, then non-bi-directional communication protocol messages are exchanged between the server and the client, additional non-bi-directional communication protocol messages are inserted as needed to maintain the conversation, and several of the non-bi directional communication protocol messages are connected as the conversation to emulate bi-directional communication between the client and the server. Application programming is layered over the server software object and the conversation so that the conversation appears fully bi-directional to the application programming.

A method of emulating a bi-directional communications connection between a server and a client is presented according to another aspect of the invention. According to the method, a server software object is created at the server to control the exchange of communication protocol messages between the server and the client from the perspective of the server and to isolate higher level server programming that calls the server software object from the exchange. Whether or not the server and the client are exchanging communication protocol messages via at least one intermediary server is determined. Control over the exchange of communication protocol messages is transferred away from the server software object if the server and the client are not exchanging communication protocol messages via at least one intermediary server. Otherwise, several of the communication protocol messages are connected as a conversation. The several communication protocol messages each include an identifier that is associated with the server software object and the conversation.

A method of automatically adapting to the presence of an intermediary server between a server and a client is presented according to a further aspect of the invention. According to the method, an initial request is received from the client at the server. The initial request is intended to begin a conversation between the server and the client. A first server software object is created to handle the conversation. A first circuit identifier is associated with the first server software object. A response is sent to the client as part of the conversation. Further processing of the conversation is blocked until a second request that includes the first circuit identifier is received from the client. If the second request received from the client at the server includes the first circuit identifier, then the first server software object is found, and processing of the conversation is unblocked. In addition, if the second request was passed through an intermediary server, then at least one successive response is sent to the client. Each successive response includes the first circuit identifier and triggers a corresponding request from the client that includes the first circuit identifier, except for a final response of the at least one successive response.

A method of processing requests at a server is presented according to another aspect of the invention. The server is in communication with at least one client. According to the method, requests from a client are flexibly routed and processed according to whether or not the request is intended to open one conversation between the server and the client, whether or not the request includes a circuit identifier that corresponds to a previously existing other conversation between the server and the client, and whether or not the request arrived from the client via an intermediary server connected between the server and the client. Higher level programming is isolated from the routing and processing of the requests.

A server to communicate with a client is presented according to a further aspect of the invention. The server includes a software object, a request processing interface, and a software routine. The software object determines whether or not a client is using any intermediary server that is compatible with a non-bi-directional communication protocol to communicate with the server. The software object flexibly manages a conversation between the server and the client according to a bi-directional communication protocol if the any intermediary server is not being used and according to the non-bi -directional communication protocol if the any intermediary server is being used. The request processing interface receives requests from the client and creates the software object responsively to receiving any request from the client that belongs to a first request category. The software routine calls the software object to perform a task that is associated with the first request category and to run an arbitrary communication protocol with no awareness of whether or not the client is using any intermediary server to communicate with the server. The software routine operates at a higher level than the software object.

A system that automatically adapts communications between a server and a client to the presence or absence of an intermediary server between the server and the client and isolates a higher-level application program from the details of the communications is presented according to another aspect of the invention. The system includes a server and a client. The server creates a server software object to receive requests and to send responses. The client selects which protocol of at least two communication protocols to use to communicate with the server based on a destination address. The client creates a client software object to send requests and to receive responses. The server software object and the client software object allow an application program to communicate using the at least two communication protocols without direct knowledge of the at least two communication protocols. One protocol of the at least two communication protocols is bi-directional to allow the client to send requests to the server and the server to send responses to the client once a connection between the server and the client has been initiated. Another protocol of the at least two communication protocols is non-bi-directional to allow only a single request from the client and a single response from the server per connection that is initiated between the server and the client. The client selects the other protocol to use if the destination address designates an intermediary server. The server sends a response to the client according to a type of request that is sent by the client. The server, when responding to a first type of request from the client that requires a single response, sends a response according to whichever protocol of the at least two communication protocols the first type of request corresponds. The server, when responding to a second type of request from the client that requires a more complex conversation with the client, uses the server software object to manage the conversation. If the client uses the other protocol to communicate with the server, the server assigns a circuit identifier to the software object and routes future requests carrying the circuit identifier to the software object. The client and the server insert additional messages as needed to maintain the conversation when the other protocol is used.

A client to initiate a connection to, to communicate with, and to send a request to a server in a communications network is presented according to a further aspect of the invention. The client selecting which protocol of at least two communication protocols to use to communicate with the server based on a destination address. The client includes a software object. The software object flexibly manages a conversation between the server and the client according to one protocol of the at least two communication protocols if the client uses an intermediary server that is compatible with a non-bi-directional communication protocol to send the request to the server, and according to another protocol of the at least two communication protocols if an intermediary server is not used to send the request. The client creates the software object upon initiating the connection to the server. If the client used the intermediary server to send the request to the server, the client receives a circuit identifier in a response from the server and the client includes the circuit identifier in subsequent requests that the client sends to the server. The circuit identifier is used by the server to identify and route requests from the client. The client inserts additional requests in communication with the server to maintain the conversation if the client is managing the conversation according to the one protocol.

### BRIEF DESCRIPTION OF THE DRAWINGS

The foregoing and other features, aspects, and advantages will become more apparent from the following detailed description when read in conjunction with the following drawings, wherein:

FIG. 1 is a diagram illustrating an exemplary direct connection between a client and a server without a proxy server according to a presently preferred embodiment; and

FIG. 2 is a diagram illustrating an exemplary indirect connection between the client and the server via a proxy server through a firewall according to a presently preferred embodiment;

FIG. 3 is a diagram illustrating an exemplary indirect connection between the server and the client via a Web server through a firewall according to a presently preferred embodiment;

FIG. 4 is a state machine diagram illustrating a portion of the operation flow and states of an exemplary client circuit object operating on the client of FIGS. 1-3;

FIG. 5 is a flow diagram illustrating an overview of exemplary message processing at the server of FIGS. 1-3;

FIG. 6 is a flow diagram illustrating exemplary message processing at the server of FIGS. 1-3; and

FIG. 7 is a state machine diagram illustrating a portion of the operation flow and states of an exemplary server circuit object operating on the server of FIGS. 1-3.

### DETAILED DESCRIPTION OF THE PRESENTLY PREFERRED EMBODIMENTS

The present invention will now be described in detail with reference to the accompanying drawings, which are provided as illustrative examples of preferred embodiments of the present invention.

The presently preferred embodiments described herein include systems and methods for emulating a bi-directional communications connection between a server and a client and for automatically adapting to the presence or absence of a proxy server between the server and the client. The methods and systems described herein allow a series of HTTP request/response transactions to be used to emulate a more fully bi-directional communications channel between a client and a server in a communications network. The subject of this invention is a software object that can represent both a direct connection or a connection via a proxy server, hide the underlying limitations of the transport from the application using it, and in so doing, simplify the programming interface for an application programmer.

This invention allows two software processes to communicate using either a direct bi-directional TCP socket protocol, or using HTTP protocol as the transport mechanism, in a more free-form fashion than would normally be allowed by the HTTP protocol. That is, the presently preferred embodiments present an alternative to restricting the protocol between the client and server to the simpler HTTP request/response paradigm.

Simple, short conversations between the client and the server are well suited to the single request, single response nature of HTTP. When it is necessary for the client and the server to engage in more complicated dialogs, where the simple request/response paradigm is too limited, a circuit object is used.

The presently preferred embodiments use respective software objects in the server to connect a series of requests received at the server and in the client to connect a series of responses received at the client, thus emulating a persistently connected socket, in a manner akin to the well-known concept of a session in HTTP. In the case of the server and the client communicating via one or more proxy servers and using HTTP, the software objects send dummy request/responses so as to shield the respective program that calls the respective object from having to take into account the single request/single response nature of HTTP. The presently preferred embodiments integrate this approach with the more efficient use of a, for example, direct TCP connection when no proxy server is present.

By encapsulating the complexity of two disparate means of communications inside the circuit objects, it is possible to make the application using this mechanism more readable, reliable and maintainable than conventional implementations.

According to a presently preferred embodiment, a client software object and a server software object are created that allow an application program to communicate using two or more communication protocols: one of which is bi-directional, that is, that allows either side to send data once the connection has been initiated, and one of which allows, at a minimum, the exchange of a single request and a single response. The client software object selects which of the two or more protocols to use depending on the destination address. The server, when responding to a simple request that requires just a single response, responds directly to the request, formatting its response according to the requirements of the protocol of the received request. The server, when responding to a complex request, creates a software object to process communication protocol messages and to manage a server side of the conversation. This software object is assigned an identifying circuit number that is used throughout the remainder of the conversation with the client. Requests arriving at the server are checked for the presence of the circuit number and are routed to the software object associated with that circuit number for processing. When communicating via a simple request/response protocol such as HTTP, the client and server software objects insert extra messages, which are consumed by the peer object when more than one message needs to be sent or received from client to server or from server to client.

In the presently preferred embodiments described herein, the communication of two processes is enabled through the intermediary action of HTTP proxy servers. Of course, other protocols may be substituted for TCP or HTTP, as suitable, such as the User Datagram Protocol (UDP), a protocol that is compatible with the Internet Packet exchange (IPX) protocol, or the IPX protocol itself. For HTTP in particular any suitable protocol may be substituted in which a single request elicits a single response and in which arbitrary data are capable of being encapsulated. Preferably, such a suitable protocol would be allowed to pass through firewalls or appropriate other security protecting a distributed computing system from an untrusted network.

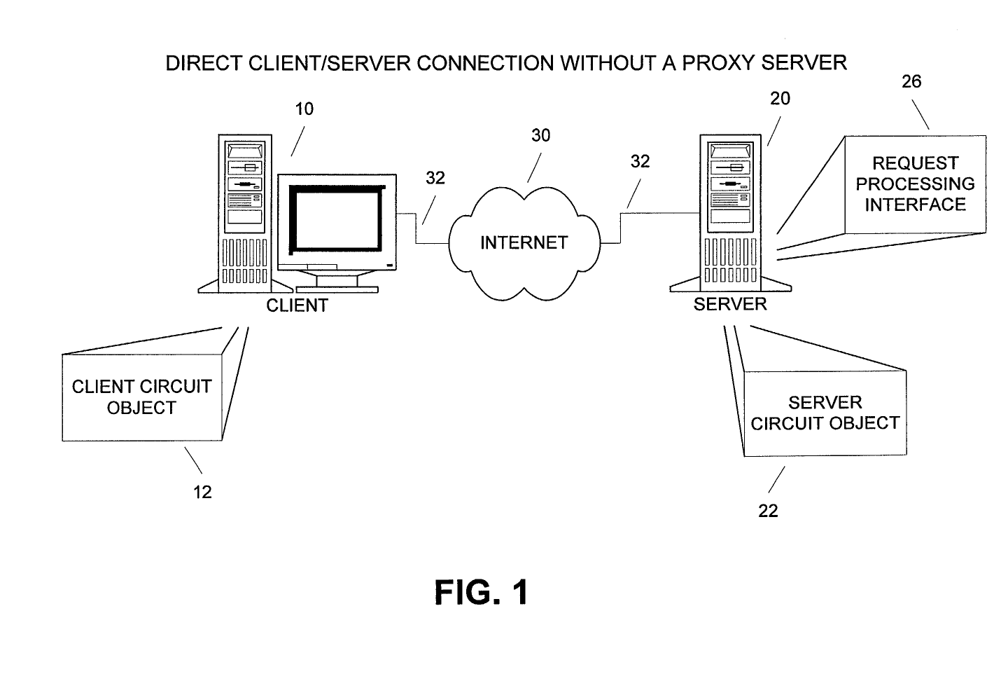

FIG. 1 is a diagram illustrating an exemplary direct connection between a client 10 and a server 20 without a proxy server according to a presently preferred embodiment. The client 10 communicates with the server 20 over the Internet 30 over a direct communication link 32. The client 10 includes a client circuit object 12. Similarly, the server 20 includes a server circuit object 22 and a request processing interface 26.

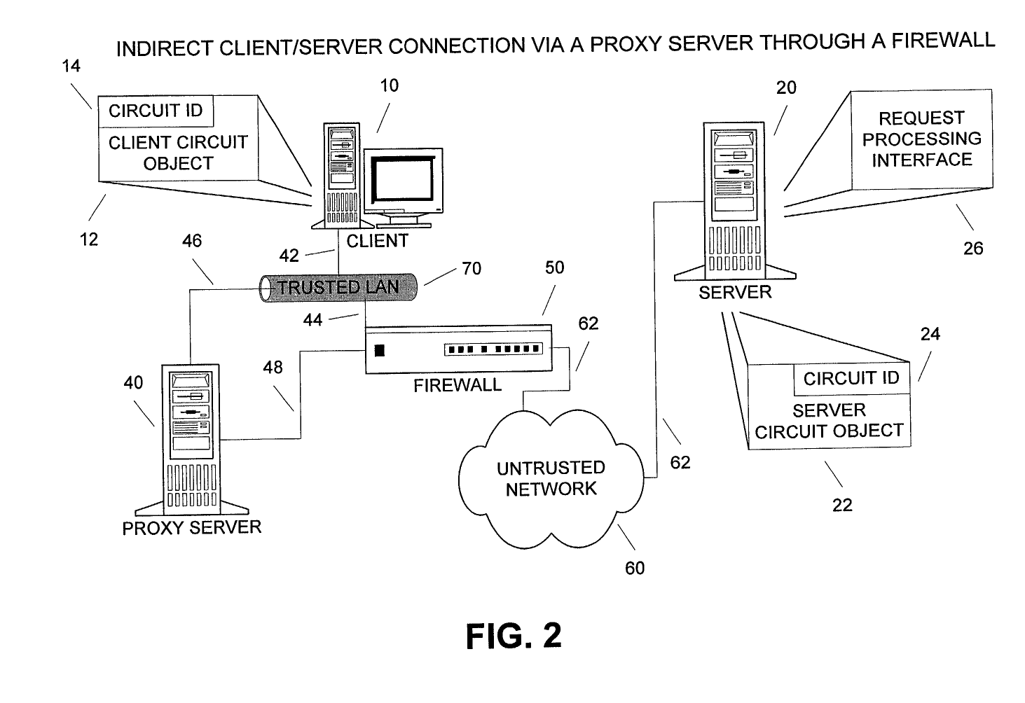

FIG. 2 is a diagram illustrating an exemplary indirect connection between the client 10 and the server 20 via a proxy server 40 through a firewall 50 according to a presently preferred embodiment. An untrusted network 60 separates the server 20 from a protected network that includes the client 10, the firewall 50, the proxy server 40, and a trusted local area network (LAN) 70 to which the client 10 belongs. The firewall 50 prevents the establishment of, for example, TCP connections from outside the protected network to machines on the inside of the network, or connections from inside the protected network outward except through the agency of proxy server 40. The proxy server 40 enables certain communications from inside the firewall 50 to outside, without allowing untrusted machines outside the protected network to connect directly to trusted machines on the inside. Preferably, the proxy server 40 is compatible with HTTP, although any single request/single response protocol used in conjunction with a firewall or other appropriate network security device could be used as suitable.

The client 10 communicates with the trusted LAN 70 over a link 42. The trusted LAN 70 communicates with the firewall 50 over a link 44 and with the proxy server 40 over a link 46. The firewall 50 communicates with the proxy server 40 over a link 48 and with the server 20 via the untrusted network 60 over a link 62.

As described above, the client 10 includes the client circuit object 12. Similarly, the server 20 includes the server circuit object 22 and the request processing interface 26. The client circuit object 12 manages a corresponding conversation between the client 10 and the server 20 from the client 10 side. The server circuit object 22 manages a corresponding conversation between the server 20 and the client 10 from the server 20 side. As explained in more detail below, in the case of communication over the proxy server 40 as in FIG. 2, a circuit identifier (ID) 14 is associated with a conversation on the client 10 side and is included in the client circuit object 12. Similarly, if the proxy server 40 is used by the client 10 to communicate with the server 20, a circuit ID 24 is associated with a conversation on the server 20 side and is included in the server circuit object 22. According to a presently preferred embodiment, if the client circuit object 12 and the server circuit object 22 refer to the same conversation between the client 10 and the server 20, then the circuit IDs 14, 24 will be identical.

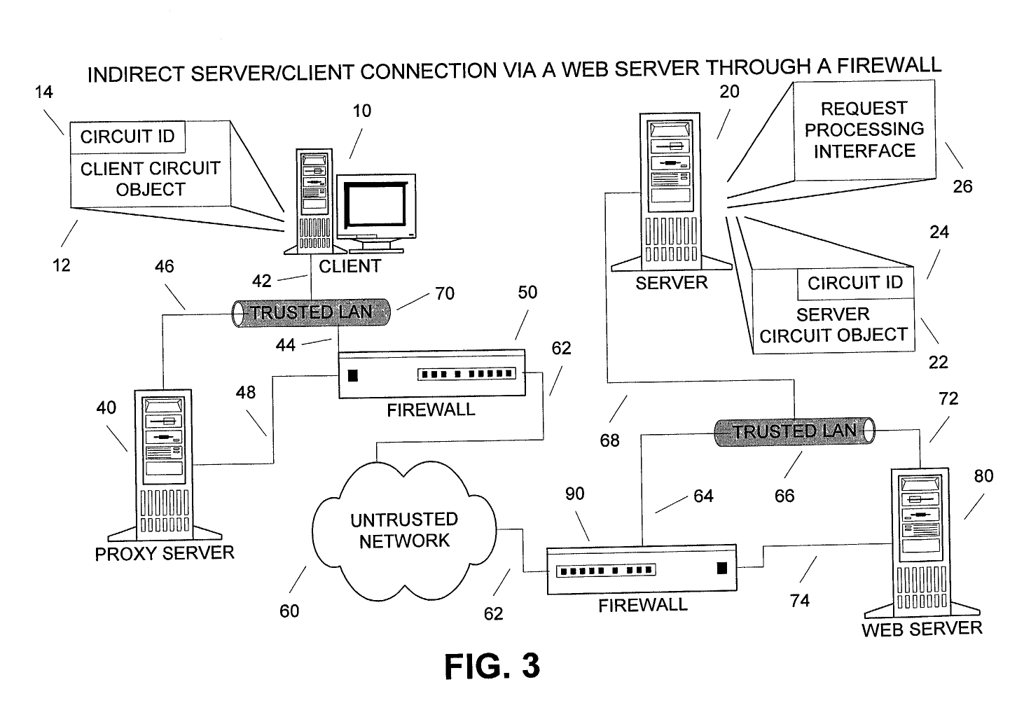

Other embodiments than those illustrated in FIGS. 1 and 2 are possible according to aspects of the present invention. For example, a firewall may be used for server-side communications. FIG. 3 is a diagram illustrating an exemplary indirect connection between the server 20 and the client 10 via a Web server 80 through a firewall 90 according to a presently preferred embodiment. Instead of being directly connected to the untrusted network 60, the server 20 communicates with the protected network of the client 10 via the firewall 90, the Web server 80, and a trusted local area network (LAN) 66 to which the server 20 belongs.

In some respects, the exemplary connection illustrated in FIG. 3 operates analogously to the exemplary connection illustrated in FIG. 2 and described above. The exemplary connection in FIG. 3 is intended to highlight an exemplary use of the Web server 80. The Web server 80 preferably acts as a relay server to provide proxy server support for the server 20, for example, relaying messages to the server 20. A relay server is, for example, an HTTP Web server that acts as a server side proxy. For example, the client 10 connects to the proxy server 40. The proxy server 40 then connects via the untrusted network 60 to the Web server 80. The Web server 80 relays the message from the client 10 to the server 20 behind the server side firewall 90. The server side firewall 90 preferably allows incoming HTTP traffic to be directed to the Web server 80. The Web server 80 preferably has a component that redirects specific wrapped messages to the server 20. The server 20 then processes the messages in the same way that the server 20 would process a message from a proxy server. Although the proxy server 40 is shown in FIG. 3, in other embodiments the proxy server 40 is not included. Although the Web server 80 preferably performs a proxy server function, in other embodiments, a proxy server could be included behind the server side firewall 90.

Although one client circuit object 12 is illustrated in FIGS. 1-3, in general there may be any number of client circuit objects 12 as suitable. Similarly, although one server circuit object 22 is illustrated in FIGS. 1-3, in general there may be any number of server circuit objects 22 as suitable. As explained in more detail below, each circuit object 12, 22 uniquely corresponds to a conversation between the client 10 and the server 20.

Each side of the channel between the server 20 and the client 10 maintains a software object, that is termed a circuit or circuit object in a presently preferred embodiment. Each circuit or circuit object 12, 22 maintains the state of a particular conversation between the server 20 and the client 10. A generic circuit object preferably contains a circuit identifier (ID) 14, 24,and a member variable. The circuit ID 14, 24 is a serial number that is issued by the server 20 and that is used by the server 20 and the client 10 to distinguish various simultaneous conversations from each other. The member variable describes the current state of the circuit object 12, 22. In a presently preferred embodiment, the states of the circuit object 12, 22 are the following:

DISCONNECTED: indicates that the circuit is disconnected,

NO_PROXY: indicates that the client 10 is not communicating with the server 20 via a proxy server 40,

CONNECTED: indicates the circuit is connected,

LAST_ACTION_SEND: indicates that the last action of the circuit object was to send a request/response, and

LAST_ACTION_RECEIVE: indicates that the last action the circuit object was to receive a request/response.

The generic circuit object exposes the following methods and functions:

Send( ): sends a request or response, and depending on the situation, may wait for a dummy request or response to be receive prior to sending the request or response,

Receive( ): puts the object in a wait state for a request or a response to arrive, and depending on the situation, causes a dummy request or response to be sent in order to provoke a response or request from the other side, and

Complete( ): performs an action necessary to terminate the circuit.

Preferably, the generic circuit object also includes a method to send a large file. In the case of an indirect connection between the client 10 and the server 20 via the proxy server 40 as in FIG. 2, a large file is preferably sent in chunks that the proxy server 40 can accommodate. By contrast, following an initial message that announces the size of a large file, the contents of the large file can be streamed from one side to the other via this large file method over a direct connection between the client 10 and server 20.

A dummy request or response is an artificial request or response that is generated by the circuit object 12, 22 on one side (client 10 or server 20) because that circuit object knows that the circuit object on the other side wants to send something according to a higher level protocol, but cannot, until the circuit object on the one side sends an acknowledgement message to the circuit object on the other side. In the case of a proxy server 40, the circuit objects 12, 22 preferably require acknowledgement of every message that is sent back and forth, except for, preferably a final message. The higher level protocol is an operation that is running on top of the bi-directional protocol emulation that the circuit objects 12, 22 facilitate.

Depending on the implementation, more than one client 10 may be used as suitable to communicate with the server 20. Further, the server 20 and the client 10 may swap roles, that is, the machine, or application, that is identified as the client 10 in FIGS. 1-3 may act as a server in another transaction or exchange and the machine, or application, that is identified as the server 20 in FIGS. 1-3 may act as a client in another transaction. Multiple intermediary servers, such as proxy servers and relay servers may be located between the server 20 and the client 10 as suitable.

Of course, it should be understood that the configurations, connections, and communication links shown in FIGS. 1-3 are merely intended to be exemplary, and that other configurations, connections and links are possible and may be used as suitable. For example, the client 10 and the server 20 may belong to the same network. The direct communication link 32 of FIG. 1, the links 42, 44, 46, 48, 62 of FIG. 2, and the links 42, 44, 46, 48, 62, 64, 68, 72, 74 of FIG. 3, may include any suitable intermediate or intervening communication devices or networks. For example, other proxy servers might serve as intermediary between the server 20 and the client 10. The client 10 may communicate with the server 20 via the Internet 30 or via the Internet 30 and a local telephone exchange, for example.

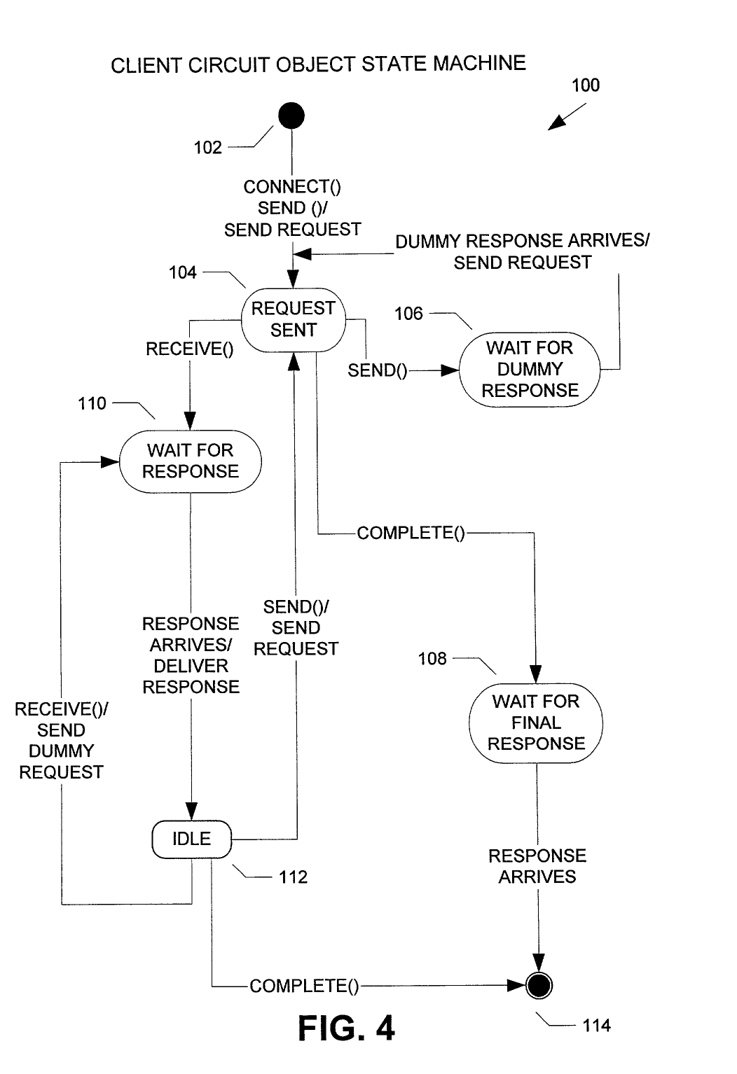

Referring now to FIG. 4, it is a state machine 100 diagram illustrating a portion of the operation flow and states of the exemplary client circuit object 12 operating on the client 10 of FIGS. 1-3. In particular, the state machine 100 diagram illustrates the behavior of the client circuit object 12 when communicating via the server proxy 40 of FIG. 2. The state machine 100 has an entry 102 and an exit 114 point as well as a Request Sent state 104, a Wait For Dummy Response state 106, a Wait For Final Response state 108, a Wait For Response state 110, and an Idle state 112.

The generic circuit object is specialized as the client circuit object 12, ClientCircuit, which adds the method Connect( ) to the above described methods Send( ), Receive( ), and Complete( ). According to a presently preferred embodiment, the client 10 initiates each conversation with the server 20 by calling the Connect( ) method, which opens a socket either directly to the server 20, in the case of a direct connection as shown in FIG. 1, or to the intermediate proxy server 40, in the case of an indirect connection as shown in FIG. 2. The client 10 then sends a request to the server 20 using the client circuit object's 12 Send( ) method.

When no proxy server is involved, the client circuit object 12 preferably maps the Send( ) and Receive( ) methods directly to the underlying socket send( ) and recv( ) functions of the TCP protocol and relinquishes control over the conversation until the conversation that is associated with the client circuit object 12 ends and the client circuit object 12 itself terminates. The client 10 and the server 20 maintain persistent socket connections and communicate with and stream data to each other at will until the conversation is over.

If, instead, the client 10 communicates with the server 20 via the proxy server 40, the client circuit object 12 preferably must wait for a response before the object 12 can send another message to the server 20. This is the proxy server 40 case that is illustrated by the state machine 100 diagram in FIG. 4. That is, when communicating via a proxy server such as the proxy server 40, the client circuit 12 implements the state machine 100.

Preferably, messages are formatted such that it is possible to distinguish between a message that has arrived over a direct connection and one that has been sent through the proxy server 40, that is, one that has been encapsulated in HTTP. The messages that come from the direct connection will not begin with the string “HTTP.” Whenever an incoming message arrives containing the string “HTTP” as its first four bytes, the HTTP header is preferably removed from the message and that message is tagged as having been wrapped in HTTP, so that a reply to the message can be similarly encapsulated and so that the circuit object 12, 22 can ascertain whether the message came from the proxy server 40 or not.

According to a presently preferred embodiment, execution of the client circuit object 12 in the proxy server 40 case begins at the entry point 102. The client 10 calls the Connect( ) method, which opens a socket to the proxy server 40. The client 10 then sends an HTTP request to the server 20 using the Send( ) method. This puts the client circuit 12 in the Request Sent state 104 from which the client circuit 12 has several potential routes to follow. Which of the routes the client circuit 12 follows is preferably dependent on the higher level protocol or process that is running over the circuit object 12, 22 processes on the client 10 and the server 20. In particular, the client circuit 12 can exit the Request Sent state 104 if the client 10 calls any one of the Receive( ), Send( ) or Complete( ) methods on the client circuit 12.

If, according to the higher level protocol, the client 10 wants to send another request to the server 20, then the client 10 calls the Send( ) method. The client circuit 12 then has to wait for the server 20 to acknowledge the initial HTTP request with a dummy HTTP response that is invisible to the higher level protocol. The client circuit 12 goes to the Wait For Dummy Response state 106 and waits for the dummy HTTP response. When the dummy response arrives, the client 10 sends a message, or follow-on request to the server 20 and returns to the Request Sent state 104. Depending on the dictates of the particular task being performed, the client 10 can continue to wait for dummy responses and send messages or can perform another action from the Request Sent state 104.

If, according to the higher level protocol, the client 10 wants to complete the conversation from the Request Sent state 104, then the client 10 calls the Complete( ) method. The client circuit 12 then has to wait for the server 20 to acknowledge the request that brought the client circuit 12 to the Request Sent state 104 with a final response. The server 20 and the client 10 are in synchronization with each other and each have knowledge of their position in the operation that the higher level protocol is running. For example, the server 20 knows to follow up the message that the client 10 sent prior to calling the Complete( ) method with a final response. The client circuit 12 goes to the Wait For Final Response state 108 and waits for the final response. When the final response arrives, the client 10 shuts down, or terminates, the client circuit object 12 and the conversation at the exit point 114. Similarly, the server 20 shuts down the server circuit object 22 that corresponds to the conversation.

Returning to the Request Sent state 104, if, according to the higher level protocol, the client 10 next wants to receive a response from the server 20, as will typically be the case following a request, then the client 10 immediately calls the Receive( ) method on the circuit object 12. The client circuit 12 then has to wait for a response from the server 20. The client circuit 12 goes to the Wait For Response state 110 and waits for the response. When the response arrives from the server 20, the client circuit 12 delivers the response for processing and proceeds to the Idle state 112.

If, according to the higher level protocol, the client 10 next wants to receive another response from the server 20, then the client 10 calls the Receive( ) method once again on the circuit object 12. Since a response was just received from the server 20 and another response is desired, the client circuit 12 sends a dummy request to the server 20 to provoke a response from the server 20. The client circuit 12 goes to the Wait For Response state 110 and waits for the response to the dummy request. When the response arrives from the server 20, the client circuit 12 delivers the response for processing and proceeds to the Idle state 112.

If, according to the higher level protocol, the client 10 next wants to send a request to the server 20 from the Idle state 112, then the client 10 calls the Send( ) method on the client circuit 12 and sends a request to the server 20. The client circuit 12 returns to the Request Sent state 104.

If instead, according to the higher level protocol, the client 10 wants to complete the conversation from the Idle state 112, then the client 10 calls the Complete( ) method. The client 10 shuts down, or terminates, the client circuit object 12 and the conversation at the exit point 114. Similarly, the server 20 shuts down the server circuit object 22 that corresponds to the conversation.

In a presently preferred embodiment, the client 10 seeks to publish content to the server 20. The particular operation of publishing content implies that the client 10 will ultimately be sending multiple requests to the server 20. Each of the multiple requests will be accompanied by groups of data that the client 10 seeks to publish to the server 20. The client 10 sends an initial request to publish content to the server 20, sending the circuit object 12 to the Request Sent state 104. The client 10 will call the Send( ) method because the client 10 is hoping to publish content and the client circuit 12 proceeds to the Wait For Dummy Response state 106. The client 10 receives the dummy response from the server 20, and assuming that the server 20 responds in the affirmative to the request to publish content, the client 10 sends a request that is accompanied by data, i.e. a portion of the content that the client 10 wishes to publish. This returns the client circuit 12 to the Request Sent state 104. In this way, the client 10 continues to send requests to the server 20, with each request being acknowledged by the server 20 with a dummy response that is invisible to the higher level protocol that is running the publish content operation over the circuit objects 12, 22. By examining the requests from the client 10, the server 20 can determine whether the server 20 should read additional requests from the client 10.

In a presently preferred embodiment, the client 10 seeks to receive results from the server 20. The particular operation of returning results implies that the server 20 will ultimately be sending multiple responses to the client 10. Each of the multiple responses will be accompanied by groups of data results that the server 20 seeks to return to the client 10 at the client's 10 request. The client 10 sends an initial request to the server 20 asking the server 20 to return results to the client 10, sending the client circuit object 12 to the Request Sent state 104. The client 10 will call the Receive( ) method because the client 10 is hoping to receive results from the server 20 and the client circuit 12 proceeds to the Wait For Response state 110. The client 10 receives the response from the server 20, and assuming that the server 20 responds in the affirmative to the request to return results the response is accompanied by data, i.e. a portion of the results that the client 10 wishes to receive. The client circuit 12 delivers the response for processing and proceeds to the Idle state 112. The client 10 wishes to continue receiving results from the server 20, but the client 10 needs to acknowledge receiving the last response, so the client 10 calls the Receive( ) method on the circuit object 12 and the client 10 sends a dummy request to the server 20 that acknowledges the receipt of the response with the results and in so doing asks for more results from the server 20. Responsively, the server 20 continues to send responses to the client 10, with each response being acknowledged by the client 10 with a dummy request that is invisible to the higher level protocol that is running the returning results operation over the circuit objects 12, 22. By examining the responses from the server 20, the client 10 can determine whether the client 10 should read additional responses from the server 20.

The generic circuit object is also specialized as the server circuit object 22, ServerCircuit as described below. The server circuit object 22 includes a condition variable that can be signaled by a main processing thread on the server 20 when a new message arrives on this circuit 22, a pointer to the circuit's 22 current message, and a socket to which to send the next response in the corresponding conversation between the server 20 and the client 10.

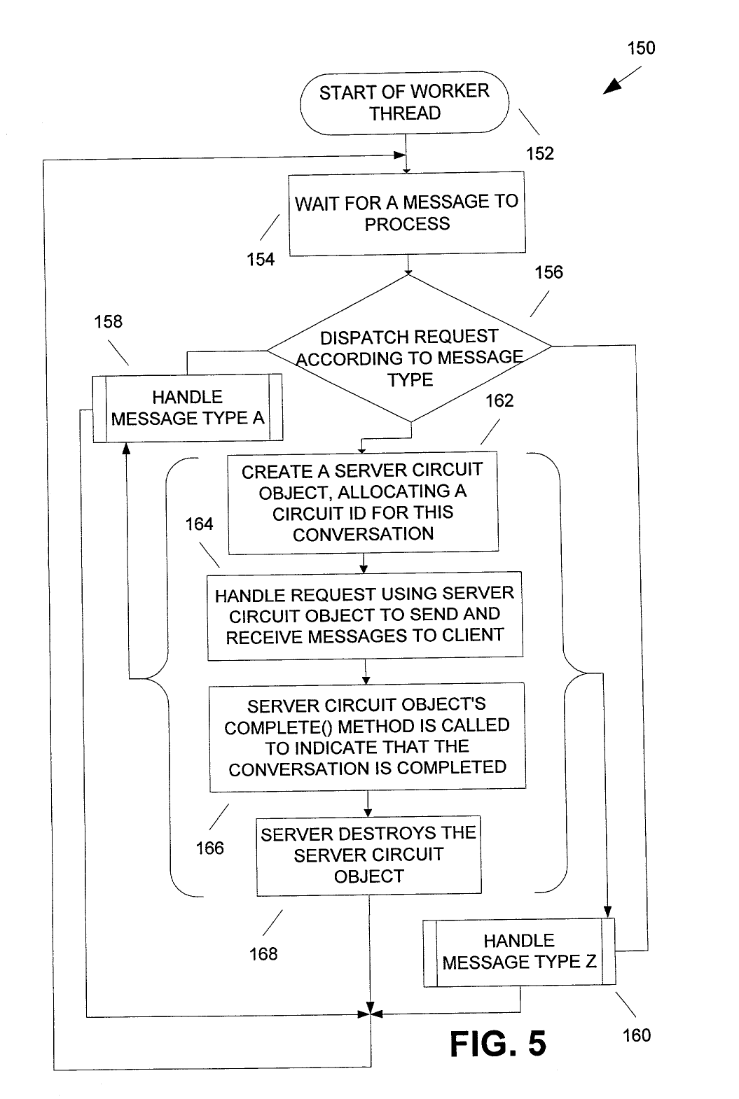

FIG. 5 is a flow diagram illustrating an overview of exemplary message processing 150 at the server 20 of FIGS. 1-3. At step 152, the worker thread begins. At step 154, the worker thread waits for a message to process. Once a message is available to process, the message is dispatched according to the type of message at step 156. The server 20 handles a variety of message types at steps 158, 160. The steps 158, 160 can themselves be separated into general operations that the server 20 preferably performs to process any message type. Thus, at step 162, the worker thread creates a server circuit object and allocates a circuit ID for this particular conversation with the exemplary client 10. At step 164, the worker thread handles the request using the server circuit object to send messages to and receive messages from the client 10. At step 166, the server circuit object's Complete( ) method is called to indicate that the conversation with the client 10 is completed. At step 168, the server 20 destroys the server circuit object since the conversation for which it was created is completed. Processing returns to step 154, where the server 20 waits for a message to process.

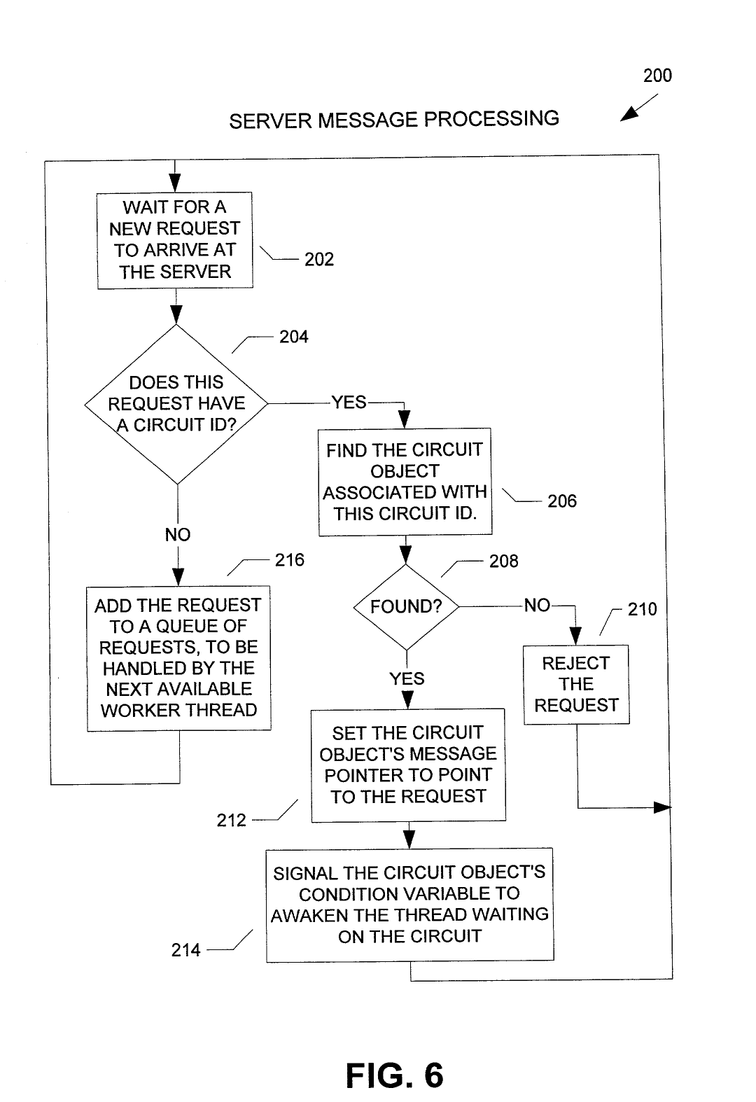

FIG. 6 is a flow diagram illustrating exemplary message processing 200 at the request processing interface 26 of the server 20 of FIGS. 1-3. At step 202, the server 20 waits for a new request to arrive from, for example, the client 10. Preferably, the client 10 initiates the conversation. After receiving a request from the client 10, at step 204, the server 20 determines whether the request received from the client 10 includes a circuit ID.

If the message/request does not have a circuit ID, then processing proceeds to step 216. At step 216, the server 20 adds the message to a queue of requests awaiting processing and preferably to handled by the next available worker thread subsidiary to a main thread of execution that runs on the server 20 and carries out the message processing 200.

In a presently preferred embodiment, at the server 20, there are two possible cases once the request is dispatched to the worker thread.

First, either the message is a simple one, which only requires a simple response from the server 20. This simple scenario maps effectively onto the single request, single response HTTP paradigm. Here, all that is needed is to generate the response to the request and, if the request was wrapped in HTTP, prepend an HTTP header to the front of the response and return the response to the client 10. No additional state machinery is needed and there is no need to create a ServerCircuit object.

Second, and alternatively, when more than a simple response from the server 20 is needed to process the request, the worker thread creates, for example, the ServerCircuit object 22 which contains the condition variable, a unique circuit ID, and the pointer to the request and the socket handle that the message/request arrived on. This case then breaks down into two sub-cases.

When the ServerCircuit object 22 is constructed, it is told whether the request arrived directly or via the proxy server 40, i.e. if the request was wrapped in HTTP. This information is used to prepend an HTTP header to the response.

In the first sub-case, the request from the client 10 was sent over a direct connection, and the Send( ) and Receive methods are mapped directly to the underlying socket send( ) and recv( ) functions. In this case, the main server 20 loop transfers ownership of the socket handle to the worker thread for the duration of the conversation. Once the circuit completes, the socket handle is returned to the server's 20 pool of available sockets.

In the second sub-case, the request from the client 10 was sent via the proxy server 40, and the server 20 sends a response to the client 10, even if the next thing the server 20 wants to do is receive. Preferably, when the server 20 asks to receive data, having just received a request from the client 10, the server 20 returns a dummy response to the client. Then the client 10 knows that the client 10 can send a request that constitutes the next part of the conversation. That first response from the server 20 to the client 10 includes a circuit ID 24 that will be used to associate subsequent incoming requests from the client 10 with this conversation. The client circuit retains the circuit ID 24 and preferably includes the value in subsequent requests.

Returning to step 204 in the message processing 200 of FIG. 6, if the request from the client 10 includes a circuit ID 14, then processing proceeds to step 206. At step 208, the server 20 attempts to find a server circuit object 22 associated with the circuit ID 14. If the server 20 is not successful, then at step 210 the server 20 rejects the request and returns to waiting for new requests to arrive at step 202. This scenario might occur if a previously existing server circuit object timed out, for example.

If the server 20 finds the server circuit object 22 associated with the circuit ID 14, then processing continues to step 212 and the server 20 sets the message pointer of the server circuit object 22 to point to the newly arrived request. At step 214, the server 20 then signals the condition variable of the server circuit object 22, which wakes up the worker thread that was waiting on the server circuit object 22 and for the next message in the conversation between the server 20 and the client 10. The worker thread wakes up, generates its response and writes that to the socket handle. The socket is then closed. For the next portion of the conversation, a new socket may be used, although the entire non-bi-directional conversation appears to the higher level application code to be a bi-directional conversation. Following execution of step 214, the server 20 request processing interface 26 returns to waiting for new requests to arrive at step 202.

In a normal, direct TCP connection the socket stays up for the duration of the conversation. In HTTP, once any single response, single request transaction is completed, then the socket that was used for the transaction is closed and the next part of the conversation comes in on a different socket. For this reason, the circuit IDs 22, 24 are used to keep track of the various conversations between the server 20 and the client 10 and/or other clients 10 of the server 20.

Every time that an HTTP message arrives via the proxy server 40, from the server's 20 point of view, the HTTP message is arriving on a different socket, because the connection is getting closed every time. Meanwhile, the client 10 actually reads directly from its socket. Every time that the client 10 goes to send a request the client 10 opens a socket, sends the request, and waits for a response on that same socket and then closes the socket.

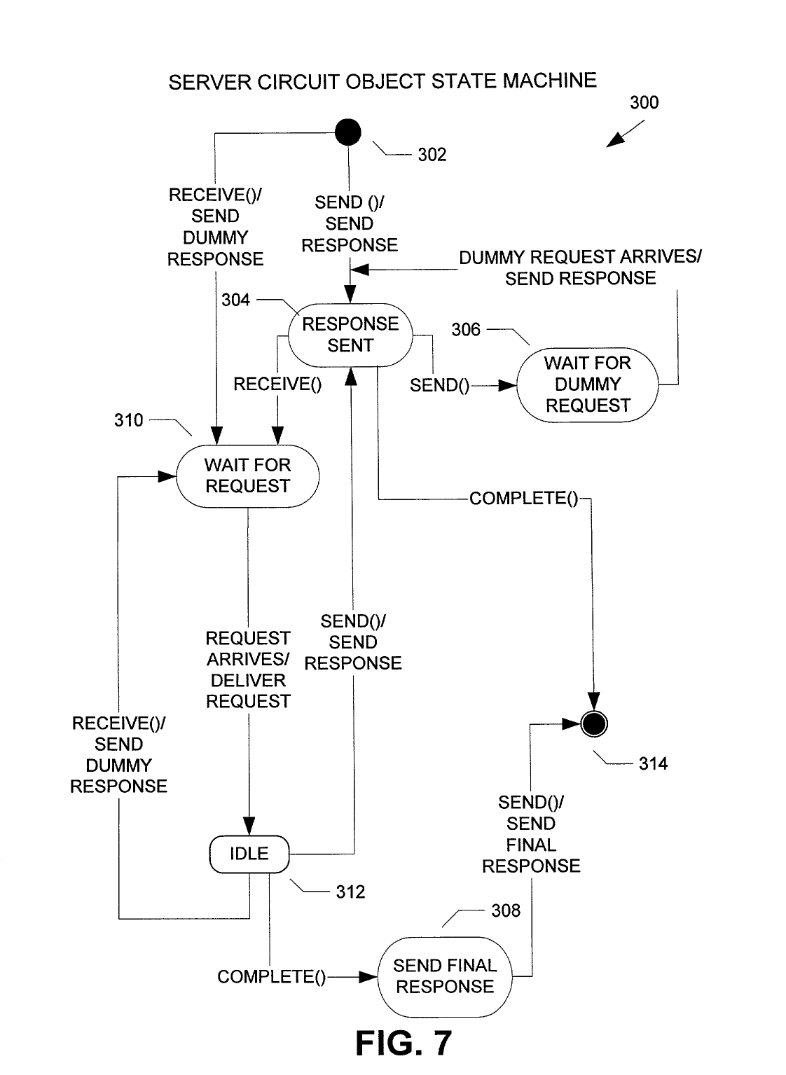

Referring to FIG. 7, it is a state machine 300 diagram illustrating a portion of the operation flow and states of the exemplary server circuit object 22 operating on the server 20 of FIGS. 1-3. In particular, the state machine 300 diagram illustrates the behavior of the server circuit object 22 when communicating via the server proxy 40 of FIG. 2. The state machine 300 has an entry 302 and an exit 314 point as well as a Response Sent state 304, a Wait For Request state 310, a Wait For Dummy Request state 306, a Send Final Response state 308, and an Idle state 312.

The Server 20 message processing 200 has been described above with reference to FIG. 6. If the client 10 communicates with the server 20 via the proxy server 40, the server circuit object 22 preferably must wait for a response before the object 22 can send another message to the client 10. This is the proxy server 40 case that is illustrated by the state machine 300 diagram in FIG. 7. That is, when communicating via a proxy server such as the proxy server 40, the server circuit 22 implements the state machine 300.

According to a presently preferred embodiment, execution of the server circuit object 22 in the proxy server 40 case begins at the entry point 302. The server 20 has received an initial HTTP request from the client 10 and has created the server circuit object 22 to manage the conversation with the client 10. Since the request arrives wrapped in HTTP, the server 20 is aware that the client 10 is communicating via the proxy server 40. The server circuit 22 has several potential routes to follow. Which of the routes the server circuit 22 follows is preferably dependent on the higher level protocol or process that is running over the circuit object 22, 12 processes on the server 20 and the client 10. In particular, the server circuit 22 can exit the entry point 302 if the server calls either the Send( ) or the Receive( ) methods on the server circuit 22.

If, according to the higher level protocol, the server 20 wants to receive another request from the client 10, then the server 20 calls the Receive( ) method. The server 20 then has to acknowledge the initial HTTP request with a dummy HTTP response that is invisible to the higher level protocol. The server 20 sends the dummy response to the client 10 and the server circuit 22 goes to the Wait For Request state 310 and waits to receive another request from the client 10.

If, according to the higher level protocol, the server 20 wants to send a response to the client 10, then the server 20 calls the Send( ) method. The server 20 then sends a response to the client 10 and the server circuit object 22 goes to the Response Sent state 304 from which the server circuit 22 has several potential routes to follow. Which of the routes the server circuit 22 follows is preferably dependent on the higher level protocol. In particular, the server circuit 22 can exit the Response Sent state 304 if the server 20 calls any one of the Receive( ), Send( ) or Complete( ) methods on the server circuit 22.

If, according to the higher level protocol, the server 20 wants to send another response to the client 10, then the server 20 calls the Send( ) method. The server circuit 22 then has to wait for the client 10 to acknowledge the initial response with a dummy request that is invisible to the higher level protocol. The server circuit 22 goes to the Wait For Dummy Request state 306 and waits for the dummy request. When the dummy request arrives, the server 20 sends a message, or follow on response to the client 10 and returns to the Response Sent state 304. Depending on the dictates of the particular task being performed, the server 20 can continue to wait for dummy requests and send messages or can perform another action from the Response Sent state 304.

If, according to the higher level protocol, the server 20 wants to complete the conversation from the Response Sent state 304, then the server 20 calls the Complete( ) method. The server 20 shuts down, or terminates, the server circuit object 22 and the conversation at the exit point 314. Similarly, the client 10 shuts down the client circuit object 12 that corresponds to the conversation.

Returning to the Response Sent state 304, if, according to the higher level protocol, the server 20 next wants to receive a request from the client 10, as will typically be the case following a response, then the server 20 immediately calls the Receive( ) method on the server circuit object 22. The server circuit 22 then has to wait for a request from the client 10. The server circuit 22 goes to the Wait For Request state 310 and waits for the request. When the request arrives from the client 10, the server circuit 22 delivers the request for processing and proceeds to the Idle state 312. In particular, as described above with regard to message processing 200 in FIG. 6 at the server 20 request processing interface 26 in FIG. 6, on the main thread of execution, the request arrives and is associated with the server circuit object 22. This in turns wakes up the worker thread that was blocked, waiting for the request from the client 10 to arrive. The worker thread can then process any data associated with the request as the worker thread sees fit.

If, according to the higher level protocol, the server 20 next wants to receive another request from the client 10, then the server 20 calls the Receive( ) method once again on the server circuit object 22. Since a request was just received from the client 10 and another request is desired, the server circuit 22 sends a dummy response to the client 10 to provoke a request from the client 10. The server circuit 22 returns to the Wait For Request state 310 and waits for the request provoked by the dummy response. When the request arrives from the client 10, the server circuit 22 delivers the request for processing and proceeds to the Idle state 312.

If, according to the higher level protocol, the server 20 next wants to send a response to the client 10 from the Idle state 312, then the server 20 calls the Send( ) method on the server circuit 22 and sends a response to the client 10. The server circuit 22 returns to the Response Sent state 304.

If, according to the higher level protocol, and in tandem with the client 10 calling the Complete( ) method for the client circuit 12, the server 20 wants to complete the conversation from the Idle state 312, then the server 20 calls the Complete( ) method. The server 20 then has to acknowledge the request that brought the server circuit 22 to the Idle state 312 with a final response. The server 20 and the client 10 are in synchronization with each other and each have knowledge of their position in the operation that the higher level protocol is running. For example, the server 20 is calling the Complete( ) method in response to the message that the client 10 sent prior to calling the Complete( ) method on its own client circuit 12. The server circuit 22 goes to the Send Final Response state 308. Then the server 20 calls the Send( ) method, sends the final response, and shuts down, or terminates, the server circuit object 22 and the conversation at the exit point 314. Similarly, the client 10 shuts down the client circuit object 12 that corresponds to the conversation.

In a presently preferred embodiment, the circuit objects 12, 22 handle one message, that is, request or response, at a time. Specifically, each circuit object 12, 22 maintains a single pointer for a single message. If a message comes in and there is already a message there that hasn't been processed, the circuit object 12, 22 will exhibit an error code, for example. Of course, it should be understood that the circuit objects can accommodate any number of messages as suitable. For example, the circuit object could maintain a queue of incoming messages that would be processed in the order received, or the messages could have accompanying sequence numbers for ordering purposes.

In a presently preferred embodiment the server uses worker threads that can be blocked so as to wait for external events, i.e. in this case, the arrival of messages from the client. It should be understood that by adding more state to the circuit object, it is possible to use the process in an event driven model. When the routine handling the circuit object on the server side needed to block, the routine would just store its state in the circuit object and return to the server. When the subsequent request arrived, the routine could recover its state from the server object and process the next phase of the request. For example, the circuit object could have a pointer to some other block of data that stores additional state information necessary to pick up the context of the conversation and carry on when a new message arrives.

Although the present invention has been particularly described with reference to the preferred embodiments, it should be readily apparent to those of ordinary skill in the art that changes and modifications in the form and details may be made without departing from the spirit and scope of the invention. It is intended that the appended claims include such changes and modifications.

What is claimed is:

1. A method of maintaining a conversation between a server and a client using either a bi-directional or a non bi-directional communication protocol, the method comprising:
creating a client software object at the client to initiate a connection with the server and to manage a conversation between the server and the client from the perspective of the client;
selecting a selected communication protocol from a set of available communication protocols that are supported by the client, the server, and any intermediary servers between the client and the server;
if the selected communication protocol is a bi-directional communication protocol, then:
exchanging bi-directional communication protocol messages between the server and the client; and
transferring control over the conversation to the bi-directional communication protocol;
if the selected communication protocol is a non-bi-directional communication protocol, then:
exchanging regular non-bi-directional communication protocol messages between the server and the client;
inserting additional non-bi-directional communication protocol messages as needed to maintain the conversation; and
connecting a plurality of the regular and additional non-bi-directional communication protocol messages as the conversation to emulate bi-directional communication between the client and the server; and
layering client application programming over the client software object and the conversation so that the conversation appears fully bi-directional to the client application programming.

2. The method according to claim 1, further comprising:
determining the set of available communication protocols at the client.

3. The method according to claim 2, wherein the act of selecting gives preference to bi-directional communication protocols of the set of available communication protocols.

4. The method according to claim 3, further comprising:
initiating a connection to the server using the selected communication protocol.

5. The method according to claim 4, further comprising:
sending an initial request to the server over the connection.

6. The method according to claim 5, further comprising:
receiving the connection at the server;
detecting the selected communication protocol at the server; and
dispatching the initial request at the server.

7. The method according to claim 6, further comprising:
creating a server software object at the server responsively to the initial request to manage a remainder of the conversation between the server and the client from the perspective of the server.

8. The method according to claim 7, further comprising:
layering server application programming over the server software object and the conversation so that the conversation appears fully bi-directional to the server application programming.

9. A method of maintaining a conversation between a server and a client using as a communication protocol either a supported one of a plurality of bi-directional communication protocols or an available one of a plurality of non bi-directional communication protocols, depending on whether a need exists to communicate via at least one intermediary server that does not support any of the plurality of bi-directional communication protocols, the method comprising:
creating a server software object at the server to process protocol messages and to manage a conversation between the server and the client from the perspective of the server;
if there is no intermediary server present between the server and the client that does not support any of the plurality of bi-directional communication protocols, then:
exchanging supported bi-directional communication protocol messages between the server and the client; and
transferring control over the conversation to the supported bi-directional communication protocol;
if at least one intermediary server is present between the server and the client that does not support any of the plurality of bi-directional communication protocols, then:
exchanging messages of a first type according to the available non-bi-directional communication protocol between the server and the client;
inserting messages of a second type according to the available non-bi-directional communication protocol as needed to maintain the conversation; and
connecting a plurality of the messages of the first type and the messages of the second type as the conversation to emulate bi-directional communication between the client and the server; and
layering application programming over the server software object and the conversation so that the conversation appears filly bi-directional to the application programming and so that the messages of the second type are concealed from the application programming.

10. A method of maintaining a conversation between a server and a client using as a communication protocol either a bi-directional communication protocol or a non bi-directional communication protocol, depending on whether a need exists to communicate via at least one intermediary server that does not support the bi-directional communication protocol, the method comprising:
creating a server software object at the server to process protocol messages and to manage a conversation between the server and the client from the perspective of the server;
if there is no intermediary server present between the server and the client that does not support the bi-directional communication protocol, then:
exchanging bi-directional communication protocol messages between the server and the client; and
transferring control over the conversation to the bi-directional communication protocol;
if at least one intermediary server is present between the server and the client that does not support the bi-directional communication protocol, then:
exchanging regular non-bi-directional communication protocol messages between the server and the client;
inserting additional non-bi-directional communication protocol messages as needed to maintain the conversation; and
connecting a plurality of the regular and additional non-bi-directional communication protocol messages as the conversation to emulate bi-directional communication between the client and the server; and
layering application programming over the server software object and the conversation so that the conversation appears fully bi-directional to the application programming.

11. A method of maintaining a conversation between a server and a client using as a communication protocol either a bi-directional communication protocol or a non bi-directional communication protocol, depending on whether a need exists to communicate via at least one intermediary server that does not support the bi-directional communication protocol, the method comprising:
creating a server software object at the server to process protocol messages and to manage a conversation between the server and the client from the perspective of the server;
determining whether or not there is at least one intermediary server present between the server and the client;
if there is no intermediary server present, then;
exchanging bi-directional communication protocol messages between the server and the client; and
transferring control over the conversation to the bi-directional communication protocol;
if at least one intermediary server is present, the at least one intermediary server being compatible with the non bi-directional communication protocol, then;
exchanging non-bi-directional communication protocol messages between the server and the client;
inserting additional non-bi-directional communication protocol messages as needed to maintain the conversation; and
connecting a plurality of the non-bi-directional communication protocol messages as the conversation to emulate bi-directional communication between the client and the server; and
layering application programming over the server software object and the conversation so that the conversation appears fully bi-directional to the application programming.

12. The method according to claim 11, wherein the additional non-bi-directional communication protocol messages are concealed from the application programming.

13. The method according to claim 11, further comprising:
creating a client software object at the client to process protocol messages and to manage the conversation between the client and the server from the perspective of the client.

14. The method according to claim 13, wherein the server software object consumes the additional non-bi-directional communication protocol messages so that the application programming is isolated from the additional non-bi-directional communication protocol messages.

15. The method according to claim 14, wherein the at least one intermediary server comprises at least one proxy server.

16. The method according to claim 14, wherein the at least one intermediary server comprises at least one relay server.

17. The method according to claim 11, wherein the non-bi-directional communication protocol is limited to a single request and a single response for a duration of the conversation.

18. The method according to claim 11, wherein the non bi-directional communication protocol is HTTP.

19. A method of emulating a bi-directional communications connection between a server and a client, the method comprising:
creating a server software object at the server to control the exchange of communication protocol messages between the server and the client from the perspective of the server and to isolate higher level server programming that calls the server software object from the exchange;
determining whether or not the server and the client are exchanging communication protocol messages via at least one intermediary server;
transferring control over the exchange of communication protocol messages away from the server software object if the server and the client are not exchanging communication protocol messages via at least one intermediary server; and
otherwise,
connecting a plurality of the communication protocol messages as a conversation, the plurality of the communication protocol messages each including an identifier that is associated with the server software object and the conversation.

20. The method according to claim 19, further comprising:
creating a client software object at the client to control the exchange of the communication protocol messages between the client and the server from the perspective of the client and to isolate client higher level programming that calls the client software object from the exchange.

21. A method of automatically adapting to the presence of an intermediary server between a server and a client, the method comprising:
receiving an initial request from the client at the server, the initial request intended to begin a conversation between the server and the client;
creating a first server software object to handle the conversation;
associating a first circuit identifier with the first server software object;
sending a response to the client as part of the conversation;
blocking further processing of the conversation until a second request that includes the first circuit identifier is received from the client; and
if the second request received from the client at the server includes the first circuit identifier; then
finding the first server software object;
unblocking processing of the conversation; and
if the second request was passed through an intermediary server, then sending at least one successive response to the client, wherein each successive response of the at least one successive response includes the first circuit identifier and triggers a corresponding request from the client that includes the first circuit identifier, except for a final response of the at least one successive response.

22. The method according to claim 21, further comprising:
processing the response and the successive responses at the client using a client software object that corresponds to the conversation.

23. A method of automatically adapting to the presence of an intermediary server between a server and a client, the method comprising:
a). receiving a request at the server from the client;
b). if the request does not include a circuit identifier, then
b1). if the request belongs to a first request category, then
b1a). sending a single response to the client; and
b2). if the request belongs to a second request category and is intended to begin a first conversation between the server and the client, then
b2a). creating a first server software object to handle the first conversation;
b2b). if no intermediary server is located between the client and the server, then
b2b1). allowing the client and the server to communicate at will over a direct connection; and
b2c). if an intermediary server is located between the client and the server, then
b2c1). creating a first circuit identifier that is associated with the first server software object;
b2c2). sending a response that includes the first circuit identifier to the client via the intermediary server; and
b2c3). successively and in turn, receiving requests from and sending responses to the client, the requests and responses including the first circuit identifier, the requests being processed at the server using the first server software object; and
c). if the request includes a circuit identifier, then
c1). finding the server software object that is associated with the circuit identifier; and
c2). processing the request at the server using the server software object, the server software object corresponding to a conversation between the server and the client.

24. The method according to claim 23, further comprising:
terminating the first server software object upon completion of the first conversation.

25. The method according to claim 23, wherein the second request category implies a more complex first conversation between the server and the client than the first request category.

26. A method of processing requests at a server, the server in communication with at least one client; the method comprising:
flexibly routing and processing requests from a client according to whether or not the request is intended to open one conversation between the server and the client, whether or not the request includes a circuit identifier that corresponds to a previously existing other conversation between the server and the client, and whether or not the request arrived from the client via an intermediary server connected between the server and the client; and
isolating higher level programming from the routing and processing of the requests.

27. An article, comprising:
a computer-readable medium having instructions stored thereon which process requests at a server, the server in communication with at least one client, which, when the instructions are executed, cause requests from a client to be flexibly routed and processed according to whether or not the request is intended to open one conversation between the server and the client, whether or not the request includes a circuit identifier that corresponds to a previously existing other conversation between the server and the client, and whether or not the request arrived from the client via an intermediary server connected between the server and the client, and cause higher level programming to be isolated from the routing and processing of the requests.

28. A server to communicate with a client, comprising:
a software object to determine whether or not a client is using any intermediary server that is compatible with a non-bi-directional communication protocol to communicate with the server, and to flexibly manage a conversation between the server and the client according to a bi-directional communication protocol if the any intermediary server is not being used and according to the non-bi-directional communication protocol if the any intermediary server is being used;
a request processing interface to receive requests from the client and to create the software object responsively to receiving any request from the client that belongs to a first request category; and
a software routine to call the software object to perform a task that is associated with the first request category and to run an arbitrary communication protocol with no awareness of whether or not the client is using any intermediary server to communicate with the server, the software routine operating at a higher level than the software object.

29. A system that automatically adapts communications between a server and a client to the presence or absence of an intermediary server between the server and the client and isolates a higher-level application program from the details of the communications, comprising:
a server to create a server software object, to receive requests, and to send responses;
a client to select which protocol of at least two communication protocols to use to communicate with the server based on a destination address, to create a client software object, to send requests and to receive responses, wherein the server software object and the client software object allow an application program to communicate using the at least two communication protocols without direct knowledge of the at least two communication protocols, one protocol of the at least two communication protocols being bi-directional to allow the client to send requests to the server and the server to send responses to the client once a connection between the server and the client has been initiated, and an other protocol of the at least two communication protocols being non-bi-directional to allow only a single request from the client and a single response from the server per connection that is initiated between the server and the client, and wherein the client selects the other protocol to use if the destination address designates an intermediary server, and wherein the server sends a response to the client according to a type of request that is sent by the client, and wherein the server, when responding to a first type of request from the client that requires a single response, sends a response according to whichever protocol of the at least two communication protocols the first type of request corresponds, and wherein the server, when responding to a second type of request from the client, the second type of request requiring a more complex conversation with the client, uses the server software object to manage the conversation, and wherein if the client uses the other protocol to communicate with the server, the server assigns a circuit identifier to the software object and routes future requests carrying the circuit identifier to the software object, and wherein the client and the server insert additional messages as needed to maintain the conversation when the other protocol is used.

30. A client to initiate a connection to, to communicate with, and to send a request to a server in a communications network, the client selecting which protocol of at least two communication protocols to use to communicate with the server based on a destination address, the client comprising:
a software object to flexibly manage a conversation between the server and the client according to one protocol of the at least two communication protocols if the client uses an intermediary server that is compatible with a non-bi-directional communication protocol to send the request to the server and according to an other protocol of the at least two communication protocols if an intermediary server is not used to send the request, wherein the client creates the software object upon initiating the connection to the server, and wherein if the client used the intermediary server to send the request to the server, the client receives a circuit identifier in a response from the server and the client includes the circuit identifier in subsequent requests that the client sends to the server, the circuit identifier being used by the server to identify and route requests from the client, and wherein the client inserts additional requests in communication with the server to maintain the conversation if the client is managing the conversation according to the one protocol.
